(19) United States
(12) Patent Application Publication
(10) Pub. No.: US 2005/0137927 A1
(43) Pub. Date: Jun. 23, 2005

(54) System and method for multi-site workforce deployment

(76) Inventor: Lisa Renee Jura, Downers Grove, IL (US)

Correspondence Address: KENYON & KENYON, 1500 K STREET, N.W., SUITE 700, WASHINGTON, DC, 20005, US

(21) Appl. No.: 10/739,130

(22) Filed: Dec. 19, 2003

(51) Int. Cl. G06F 17/60

(52) U.S. Cl. 705/9

(57) ABSTRACT

A method and system for multi-site workforce deployment. According to one embodiment, a scheduling module receives identification of an employee who is eligible to work at more than one business location of an organization, receives identification of the more than one business location at which the employee is eligible to work, and generates a labor utilization schedule for one of the more than one business location based at least upon information associated with the employee.

### BACKGROUND OF THE INVENTION

Many companies have a number of similar or identical work locations in close proximity. This situation is particularly true in the retail business, where McDonald's or Starbuck's, for example, will have a number of outlets in a given geographic area. The workload at such retail locations can be variable, the staff performs the same functions, and demand varies depending on time of day, seasonality and company activity (e.g., sales or promotions). Since labor is the second-ranking controllable expense item, any measures to control labor costs will have an impact.

Many companies currently use automated management systems to optimize workforce utilization within a single location, but there would be a considerable benefit to be able to treat all locations within a given area as belonging to a single labor pool, and to optimize utilization accordingly. For example, there are currently situations in which an employee at one location is not being offered as many hours as that person would like to work, while in another location employees are working overtime. Optimization over such an area would produce significant advantages for a company.

Unfortunately, no management system currently in use permits such optimization. Legacy systems permit optimization within a single location, and locations can work on a manual ad hoc basis to swap employees, but the existing systems treat individual operating locations as independent operations, having completely separate organizations and data structures. Moreover, such optimization cannot be carried out manually, given the time required to conduct such computations.

Accordingly, there is a need in the art for a system and method that provides optimized labor utilization schedules across locations within a given area.

### SUMMARY OF THE INVENTION

Embodiments of the present invention provide for multi-site workforce deployment. According to one embodiment, a scheduling module receives identification of an employee who is eligible to work at more than one business location of an organization, receives identification of the more than one business location at which the employee is eligible to work, and generates a labor utilization schedule for one of the more than one business location based at least upon information associated with the employee.

A scheduling module of the present invention produces an optimized staffing schedule for a group of interconnected work locations. The module may determine the schedule based on, among other things, business factors with selected weightings assigned to each factor, together with location forecasts, location budgets and employee data (e.g., skill sets, economic factors, and personal preferences).

### BRIEF DESCRIPTION OF THE DRAWINGS

FIG. 1 is a flow chart that depicts a process for multi-site workforce deployment in accordance with an embodiment of the present invention.

FIG. 2 is a block diagram that depicts the data flow and structure of multi-site workforce deployment in accordance with an embodiment of the present invention.

FIG. 3 is a block diagram that depicts a user computing device in accordance with an embodiment of the present invention.

FIG. 4 is a block diagram that depicts a system architecture for multi-site workforce deployment in accordance with an embodiment of the present invention.

FIG. 5 is a sequence diagram that depicts a multi-site workforce deployment utilization scenario in accordance with an embodiment of the present invention.

FIG. 6 is a screen shot that depicts an employee input screen in accordance with an embodiment of the present invention.

FIG. 7 is a screen shot that depicts another employee input screen in accordance with an embodiment of the present invention.

FIG. 8 is a screen shot that depicts a volume forecast screen in accordance with an embodiment of the present invention.

FIG. 9 is a screen shot that depicts a workload demand forecast screen in accordance with an embodiment of the present invention.

FIG. 10 is a screen shot that depicts a daily schedule screen in accordance with an embodiment of the present invention.

FIG. 11 is a screen shot that depicts a list replacement functionality in accordance with an embodiment of the present invention.

FIG. 12 is a screen shot that depicts a daily coverage report in accordance with an embodiment of the present invention.

FIG. 13 is a screen shot that depicts a schedule statistics report in accordance with an embodiment of the present invention.

### DETAILED DESCRIPTION

### Scheduler

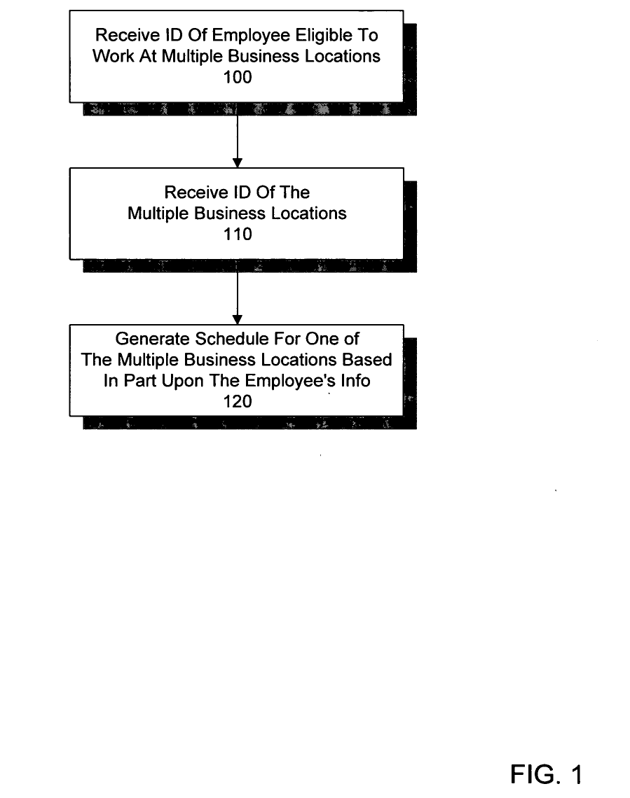

FIG. 1 depicts a process for multi-site workforce deployment in accordance with an embodiment of the present invention. A scheduling module receives identification of an employee who is eligible to work at more than one business location of an organization (step 100), receives identification of the more than one business location at which the employee is eligible to work (step 110), and then generates a labor utilization schedule for one of the more than one business location based at least upon information associated with the employee (step 120).

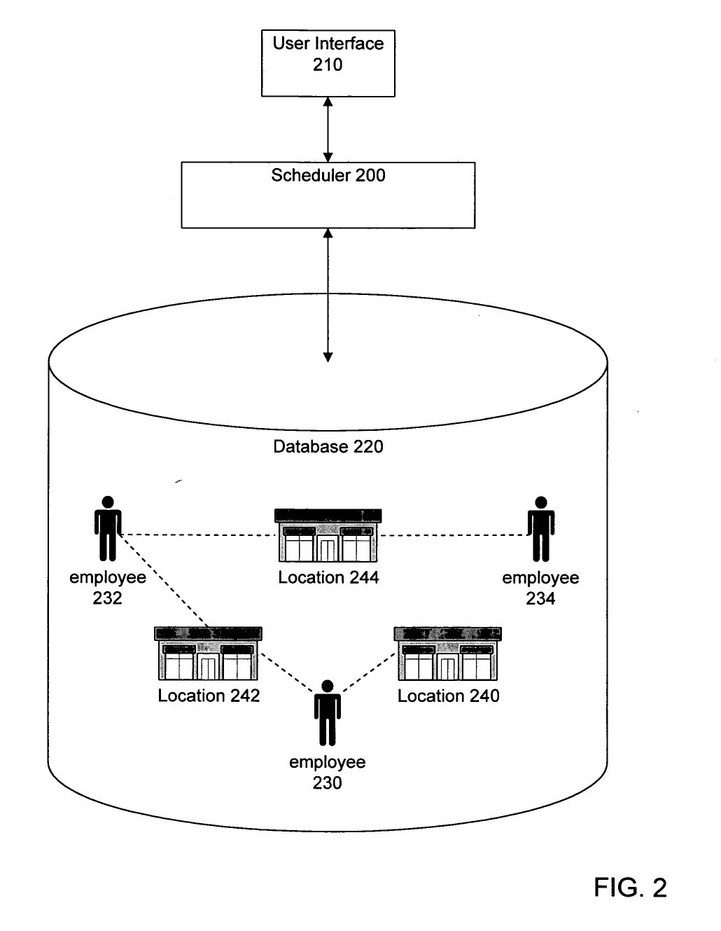

As shown in FIG. 2, in one embodiment of the present invention scheduler 200 receives through user interface 210 the identification of the employees and the business/work locations with which they are associated, and stores the information in a data store such as database 220.

In this particular example, the data representation shown in database 220 depicts a case in which employee 230 is eligible to work at both location 240 and location 242, and employee 232 is eligible to work at both location 242 and location 244; employee 234 is only eligible to work at location 244. In accordance with the present invention, when scheduler 200 generates a labor utilization schedule for location 242, for example, scheduler 200 evaluates information associated with employee 230 and 232, even though they each are also associated with other work locations (i.e., location 240 and location 244, respectively).

Scheduler 200 may utilize any number of criteria to optimize the generation of the schedule. For example, such criteria may include the store location, work area within that location (i.e., type of job such as sale, stock and cashiering), employee availability, cost (e.g., total cost, incremental cost, overtime cost, etc.), skill level of the employee (e.g., always have highest skilled people at home location, etc.) and “fairness factors” (e.g., hour load, distance from home, distance from primary location, etc.). Other criteria may include payroll (e.g., who pays whom, overtime issues, etc.), work rules (e.g., union, legal, etc.) and employee preferences (e.g., preferred work location).

### Architecture

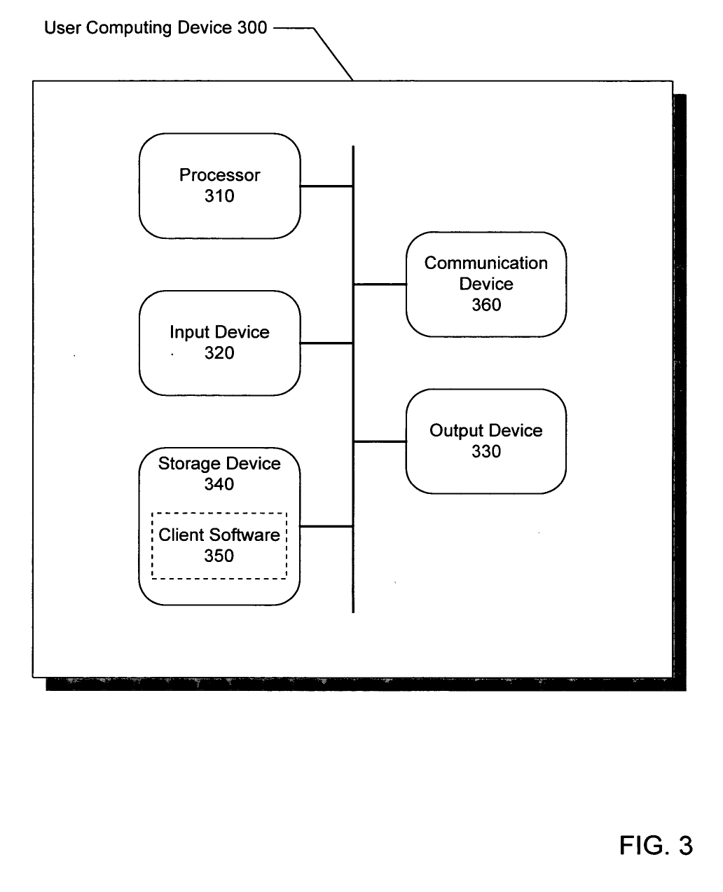

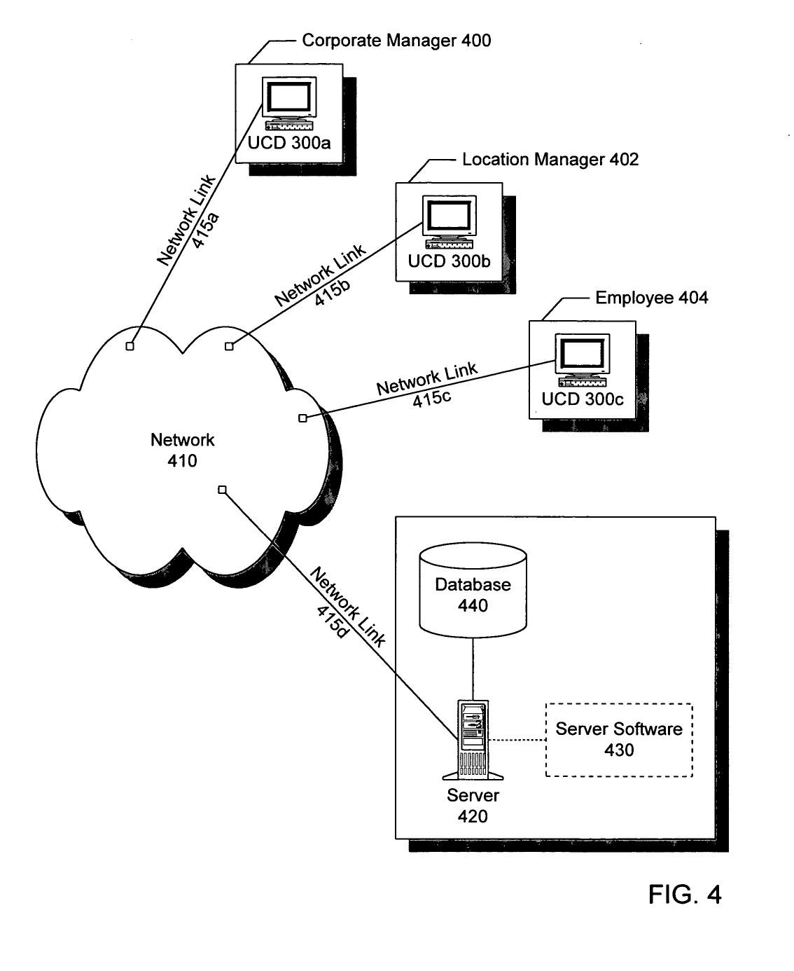

FIGS. 3 and 4 illustrate the components of a basic computer and network architecture in accordance with an embodiment of the present invention. FIG. 3 depicts user computing device 300, which may be a personal computer, workstation, handheld personal digital assistant (“PDA”), or any other type of microprocessor-based device. User computing device 300 may include a processor 310, input device 320, output device 330, storage device 340, client software 350, and communication device 360.

Input device 320 may include a keyboard, mouse, pen-operated touch screen or monitor, voice-recognition device, or any other device that accepts input. Output device 330 may include a monitor, printer, disk drive, speakers, or any other device that provides output.

Storage device 340 may include volatile and nonvolatile data storage, including one or more electrical, magnetic or optical memories such as a RAM, cache, hard drive, CD-ROM drive, tape drive or removable storage disk. Communication device 360 may include a modem, network interface card, or any other device capable of transmitting and receiving signals over a network. The components of user computing device 300 may be connected via an electrical bus or wirelessly.

Client software 350 may be stored in storage device 340 and executed by processor 310, and may include, for example, a web browser for accessing application software such as SAP Retail application StaffWorks that embodies the functionality of the present invention (including, e.g., scheduler 200 and user interface 210).

FIG. 4 illustrates a network architecture in accordance with an embodiment of the present invention. According to one particular embodiment, when corporate manager 400 (or location manager 402 or employee 404) accesses the SAP Retail application, client software 350 of user computing device 300 communicates with server software 430 (e.g., SAP Retail application StaffWorks) of server 420 via network links 415 and network 410.

Network links 415 may include telephone lines, DSL, cable networks, T1 or T3 lines, wireless network connections, or any other arrangement that implements the transmission and reception of network signals. Network 410 may include any type of interconnected communication system, and may implement any communications protocol, which may secured by any security protocol.

Server 420 includes a processor and memory for executing program instructions as well as a network interface, and may include a collection of servers. In one particular embodiment, server 420 may include a combination of enterprise servers such as an application server and a database server. Database 440 (including, e.g., database 220) may represent a relational or object database, and may be accessed via a database server.

User computing device 300 and server 420 may implement any operating system, such as Windows or UNIX. Client software 350 and server software 430 may be written in any programming language, such as ABAP, C, C++, Java or Visual Basic.

### EXAMPLE FLOW AND USER INTERFACE

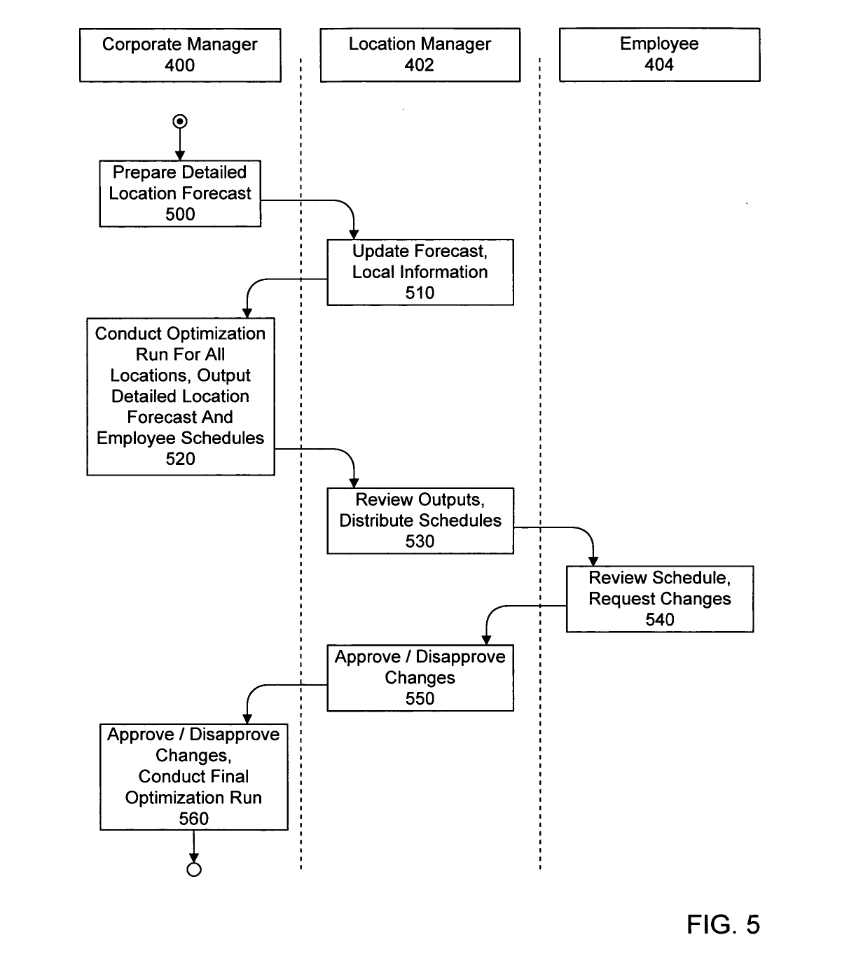

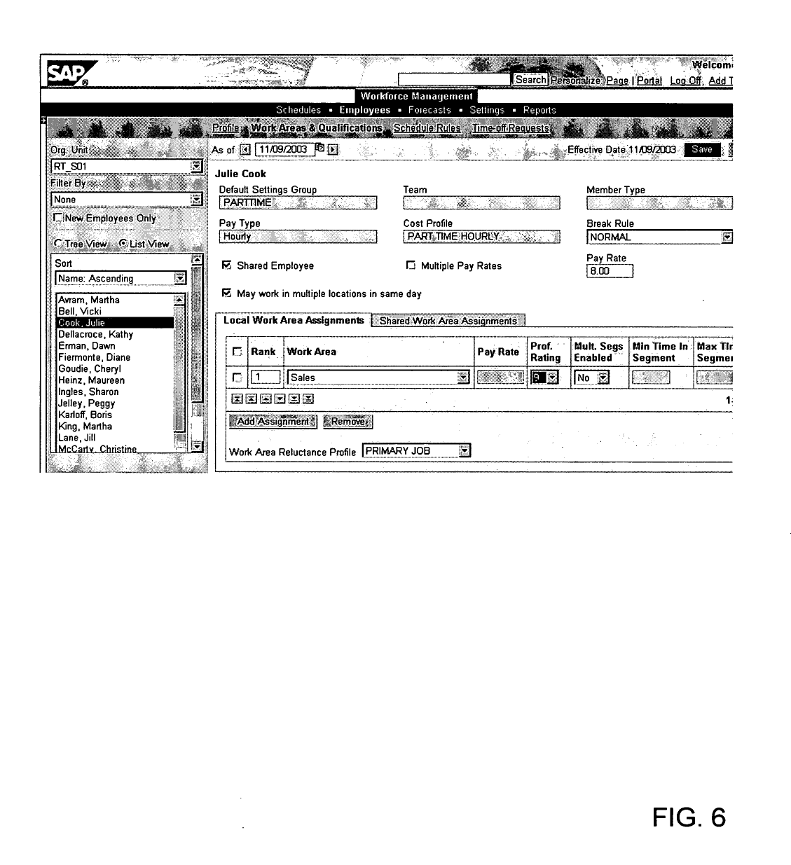

In accordance with an embodiment of the present invention, FIG. 5 depicts a multi-site workforce deployment utilization scenario, with FIGS. 6-13 illustrating representative screens of user interface 210.

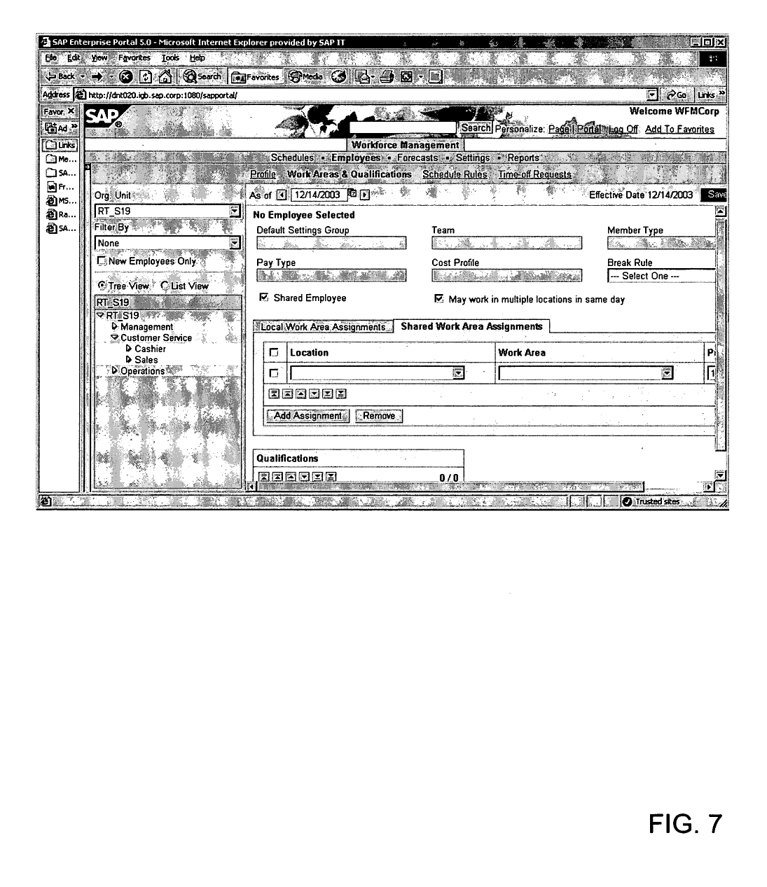

FIGS. 6-7 show exemplary screens for the input of employee information, allowing for multiple employee attributes related to pay rules, labor sharing, proficiency rating and job assignments. This information forms a basis for the optimized scheduling of labor utilization according to the present invention.

In FIG. 6, one sees from the checked boxes that employee Julie Cook is a shared employee who is eligible to work in multiple locations in the same day. Under the “Local Work Area Assignments” tab, a user can enter a ranking, work area, pay rate, proficiency rating and segment information for Ms. Cook. Rank refers to the ranking of work area assignments (jobs) within that location; for example, employees could be assigned three work areas that they could be scheduled in—sales, stock, and cashiering—and the user could rank these accordingly. The “Mult. Segs Enabled” field allows employees to be scheduled in the same work area more than once in a day; for example, based on the assigned work areas they could be scheduled in sales from 8-12, then stock from 12-3 and then sales again from 3-6. The “Work Area Reluctance Profile” allows the user to choose whether they want the employee weighted more heavily from a scheduling perspective towards their primary job assignment (rank #1) or equal importance—which will look at all jobs the same.

FIG. 7 shows the same general screen but with the “Shared Work Area Assignments” tab exposed. This screen allows the user to enter the multiple locations and work areas for which the employee is eligible.

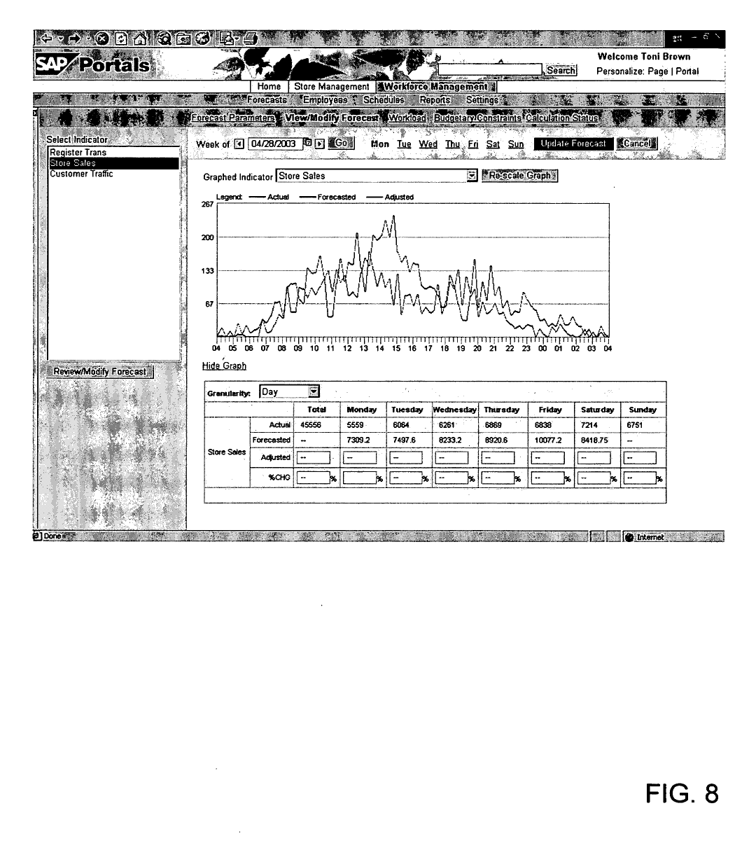

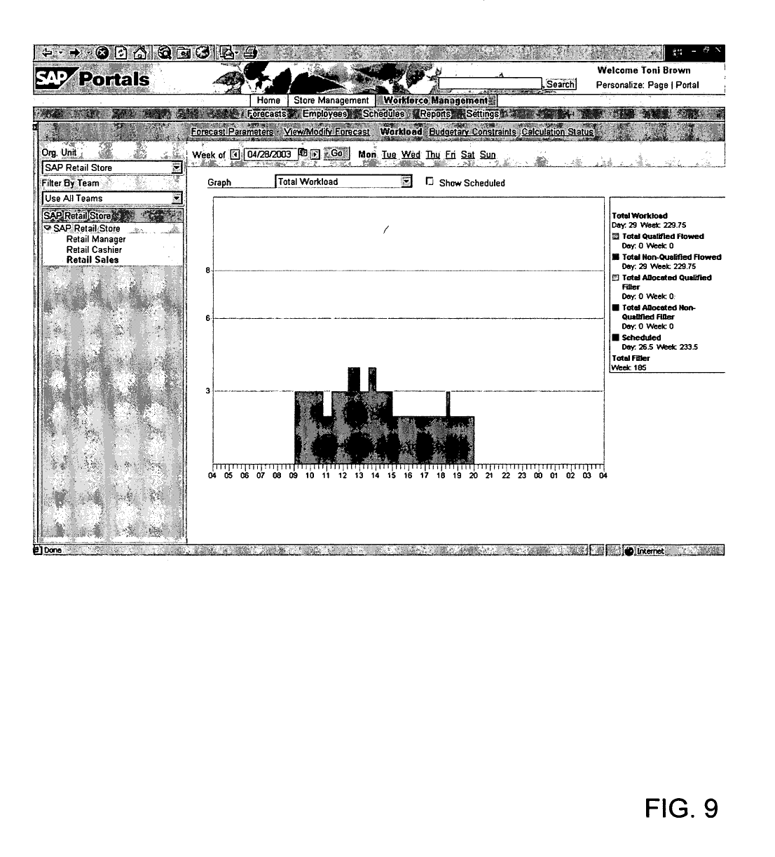

Once the employee information is entered, corporate manager 400 may prepare a detailed forecast (step 500) and release it to location manager 402 for updating with local information (step 510). FIG. 8 shows a volume forecast screen that allows location manager 402 to make changes or adjustments to the forecasted values along the bottom of the screen as needed. FIG. 9 shows a workload demand forecast screen that allows location manager 402 to navigate through the organizational hierarchy and see exactly how many employees are needed to accommodate the forecast volume.

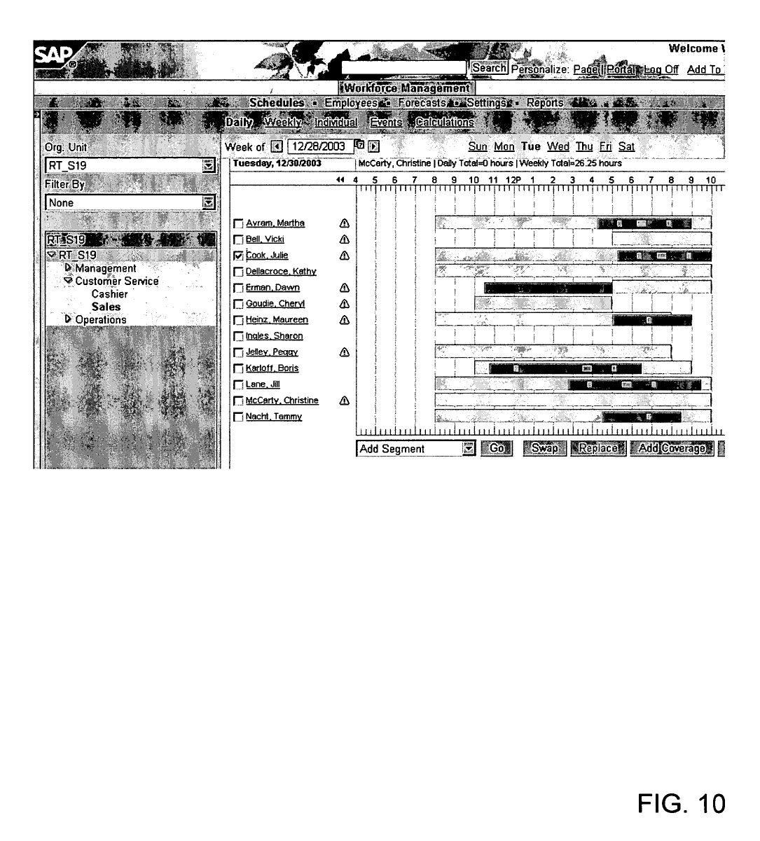

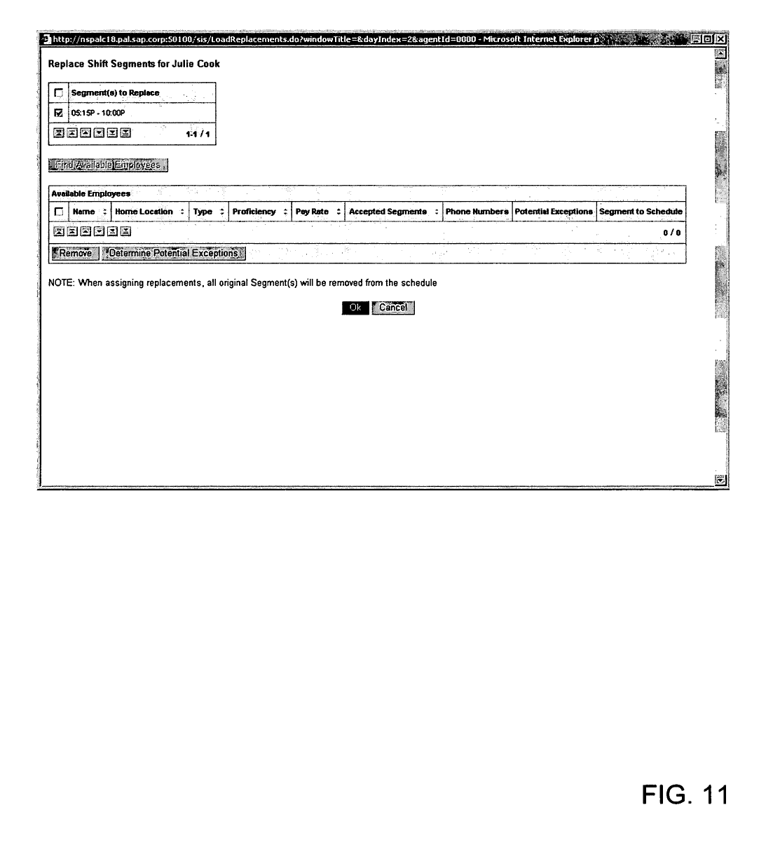

Then corporate manager 400 assembles the location inputs, conducts an optimization run for all locations and distributes the results (i.e., detailed location forecast and employee schedules) (step 520). FIG. 10 shows a daily schedule view screen that may result from such an optimization run; it allows for the review of the optimized schedule and provides for schedule maintenance such as identifying shared or pooled labor, general shift editing, shift swapping and shift replacement options. With respect to the shift replacement option, FIG. 11 shows a screen that may appear if the user clicks on the “Replace” button on the bottom of the screen in FIG. 10. This option allows the user to find available employees to cover a particular shift; shared employees are evaluated for availability when this option is chosen.

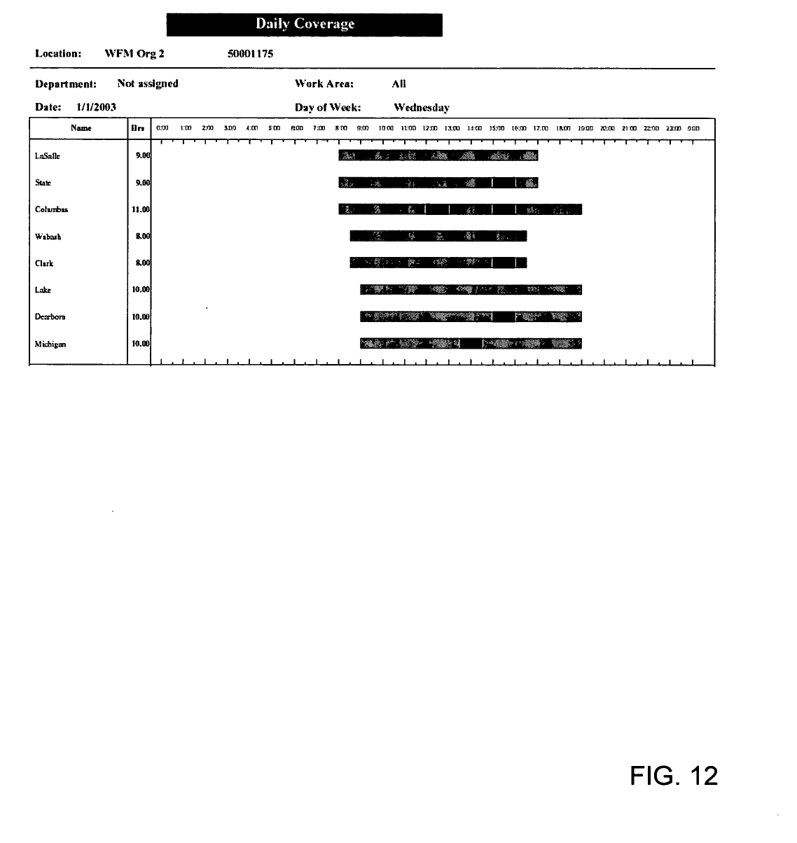

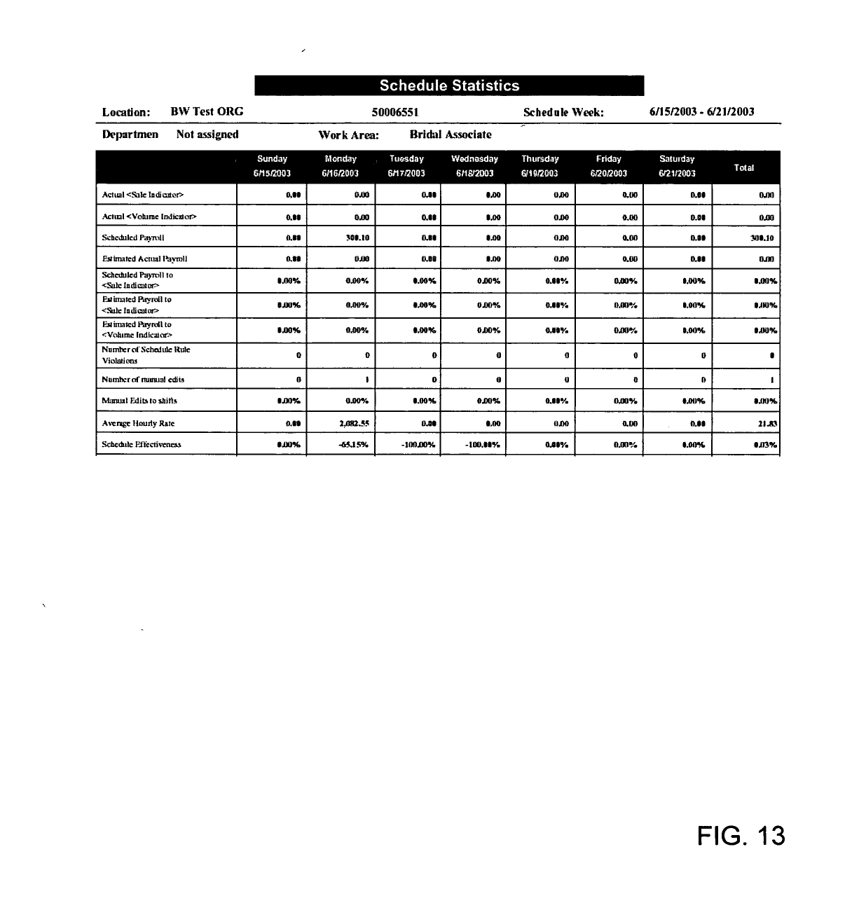

Location manager 402 then reviews the distributed results, and distributes the schedules to employee 440 (step 530) for review and any requested changes (step 540). Location manager 402 approves or disapproves any requested changes (step 550), and corporate manager 400 does the same before conducting a final optimization run (step 560). FIGS. 12-13 show a daily coverage report and a schedule statistics report, respectively, that may be generated on demand.

Several embodiments of the invention are specifically illustrated and/or described herein. However, it will be appreciated that modifications and variations of the invention are covered by the above teachings and within the purview of the appended claims without departing from the spirit and intended scope of the invention.

1. A computer-implemented method for multi-site workforce deployment, comprising:
receiving identification of an employee who is eligible to work at more than one business location of an organization;
receiving identification of the more than one business location at which the employee is eligible to work; and
generating a labor utilization schedule for one of the more than one business location based in part upon information associated with the employee.

2. The method of claim 1, wherein the identification of the employee is received through a user interface.

3. The method of claim 2, wherein the eligibility of the employee to work at the more than one business location is indicated by a designation of the employee as a shared employee in the user interface.

4. The method of claim 1, wherein the identification of the more than one business location is received through a user interface.

5. The method of claim 1, further comprising:
displaying the generated labor utilization schedule through a user interface.

6. The method of claim 5, wherein the generated labor utilization schedule graphically represents which employees are working at what times on a particular work day.

7. The method of claim 1, wherein the information associated with the employee includes the more than one business location at which the employee is eligible to work.

8. The method of claim 1, wherein the information associated with the employee includes a work area.

9. The method of claim 8, wherein the work area includes one of sales, stock, and cashier.

10. The method of claim 1, wherein the information associated with the employee includes a skill level.

11. The method of claim 1, wherein the information associated with the employee includes an availability.

12. The method of claim 1, wherein the information associated with the employee includes an economic factor.

13. The method of claim 12, wherein the economic factor includes a pay rate.

14. The method of claim 1, wherein the information associated with the employee includes a personal preference.

15. The method of claim 14, wherein the personal preference includes a business location at which the employee would most like to work.

16. The method of claim 1, further comprising:
generating the labor utilization schedule based in part upon a work rule.

17. The method of claim 16, wherein the work rule includes a union rule associated with labor utilization.

18. The method of claim 16, wherein the work rule includes a legal rule associated with labor utilization.

19. An apparatus for multi-site workforce deployment, comprising:
a processor; and
a memory storing instructions adapted to be executed by said processor to:
receive identification of an employee who is eligible to work at more than one business location of an organization,
receive identification of the more than one business location at which the employee is eligible to work, and
generate a labor utilization schedule for one of the more than one business location based in part upon information associated with the employee.

20. The apparatus of claim 19, wherein the information associated with the employee includes the more than one business location at which the employee is eligible to work.

21. The apparatus of claim 19, wherein the information associated with the employee includes a work area.

22. The apparatus of claim 19, wherein the information associated with the employee includes a skill level.

23. The apparatus of claim 19, wherein the information associated with the employee includes an availability.

24. The apparatus of claim 19, wherein the information associated with the employee includes an economic factor.

25. The apparatus of claim 19, wherein the information associated with the employee includes a personal preference.

26. The apparatus of claim 19, further comprising instructions adapted to be executed by said processor to:
generate the labor utilization schedule based in part upon a work rule.

27. A system for multi-site workforce deployment, comprising:
means for receiving identification of an employee who is eligible to work at more than one business location of an organization;
means for receiving identification of the more than one business location at which the employee is eligible to work; and
means for generating a labor utilization schedule for one of the more than one business location based at least upon information associated with the employee.

28. The system of claim 27, wherein the information associated with the employee includes the more than one business location at which the employee is eligible to work.

29. The system of claim 27, wherein the information associated with the employee includes a work area.

30. The system of claim 27, wherein the information associated with the employee includes a skill level.

31. The system of claim 27, wherein the information associated with the employee includes an availability.

32. The system of claim 27, wherein the information associated with the employee includes an economic factor.

33. The system of claim 27, wherein the information associated with the employee includes a personal preference.

34. The system of claim 27, further comprising:
means for generating the labor utilization schedule based in part upon a work rule.
